(19) United States
(12) Patent Application Publication
(10) Pub. No.: US 2017/0011184 A1
(43) Pub. Date: Jan. 12, 2017

(54) Method of Adaptively Predicting Blood-Glucose Level by Collecting Biometric and Activity Data with A User Portable Device

(71) Applicants: Ayodele Ajayi, Lewisville, TX (US); John Cain, Phoenix, AZ (US)

(72) Inventors: Ayodele Ajayi, Lewisville, TX (US); John Cain, Phoenix, AZ (US)

(21) Appl. No.: 15/204,984

(22) Filed: Jul. 7, 2016

Related U.S. Application Data
(60) Provisional application No. 62/189,280, filed on Jul. 7, 2015.

(51) Int. Cl. G06F 19/00; H04L 29/08; H04W 4/00

(52) U.S. Cl. CPC G06F 19/345; H04W 4/008; H04L 67/10

(57) ABSTRACT

A method of adaptively predicting blood-glucose level by collecting biometric and activity data with a user portable device utilizes a portable computing device carried by a user to collect movement data and biometric data about and from the user. Collected data is processed by a blood glucose prediction formula generation algorithm in order to produce multiple blood glucose level prediction formulas. Based on the activity level measured by the device, a corresponding blood glucose prediction formula is used to predict blood glucose levels for a certain period of time. The prediction formulas recursively provide feedback and change for successive iterations and new formulas are generated as new data is collected.

### FIELD OF THE INVENTION

The present invention relates generally to health measurements. More particularly, the present invention relates to accurate prediction of blood glucose levels.

### BACKGROUND OF THE INVENTION

Patients with diabetes must constantly monitor their blood glucose levels and adjust insulin doses to keep their blood glucose levels as close to normal as possible. When blood glucose levels are out of their normal range, serious short-term and long-term complications may occur. Systems that can predict future blood glucose levels can notify the patient of imminent changes, enabling them to take preventive action. Current blood glucose systems have limited predictive algorithms to determine future blood glucose values in real-time. Typical closed loop systems rely on a single algorithm to predict blood glucose levels using real-time data. These systems do not factor in the user's daily activity, their environment and/or metabolic rate, which makes the current systems blood glucose predictive values valid for only a short time period. Current systems do not account for the constantly changing factors for each unique individual.

Therefore, it is the main objective of the present invention to provide a system that is capable of predicting a patient's blood glucose level with accuracy for up to 2 hours, accounting for the various changes in activity of the user. The present invention will utilize a device for collecting data relating to the blood glucose levels of an individual. The system as a whole will learn the patient's behavior and constantly derive a new equation for each user based on their daily activity. It is understood that each patient is unique and requires a personalized equation which must be constantly derived to accurately predict their future blood glucose levels. Therefore, it is another objective of the present invention to provide a system that uniquely predicts patients' blood glucose levels through personalized formulas that are constantly changing based on their behavior.

### BRIEF DESCRIPTION OF THE DRAWINGS

FIG. 1A is a system diagram with two portable devices.

FIG. 1B is a system diagram with one portable device.

FIG. 2A is a stepwise flow diagram describing the steps of the overall process of the present invention.

FIG. 2B is a continuation of FIG. 2A.

FIG. 3 is a stepwise flow diagram specifying details of the overall process.

FIG. 4 is a stepwise flow diagram describing steps for using two portable devices.

FIG. 5 is a stepwise flow diagram describing steps for using one portable device.

FIG. 6 is a stepwise flow diagram describing steps for collecting user movement data.

FIG. 7 is a stepwise flow diagram describing steps for collecting user biometric data.

FIG. 8 is a stepwise flow diagram describing steps for designating a specific activity level.

FIG. 9 is a stepwise flow diagram describing steps for computing a predictive blood-glucose model.

FIG. 10 is a stepwise flow diagram describing steps for designating a preceding blood-glucose result for an initial iterative blood-glucose calculation.

FIG. 11 is a stepwise flow diagram describing steps for determining a preceding blood-glucose result for a subsequent iterative calculation following an arbitrary iterative calculation.

FIG. 12 is a stepwise flow diagram describing steps for adjusting coefficients of the blood-glucose predictive formulas.

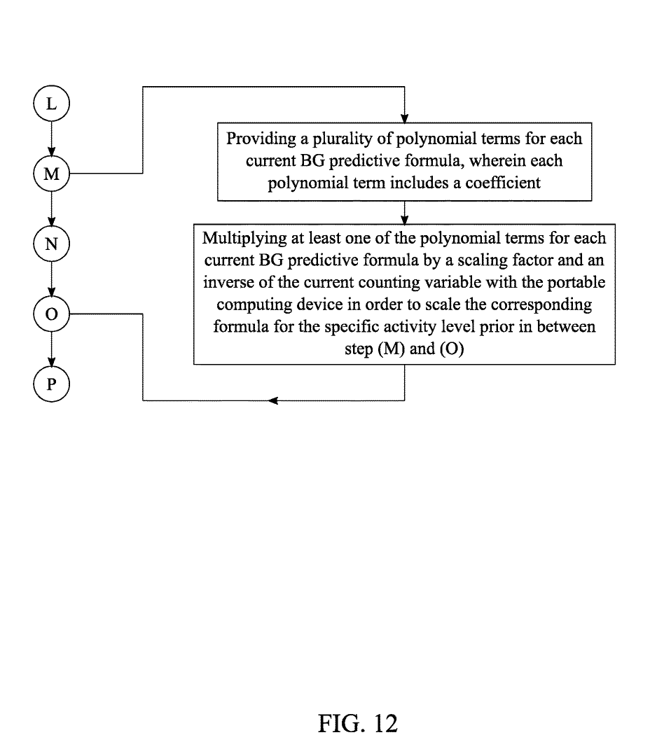

FIG. 13 is a flow diagram showing the general process of the present invention.

FIG. 14 depicts a graphical representation of the blood glucose predictive values vs the dataset.

FIG. 15 shows an example blood glucose calculation.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

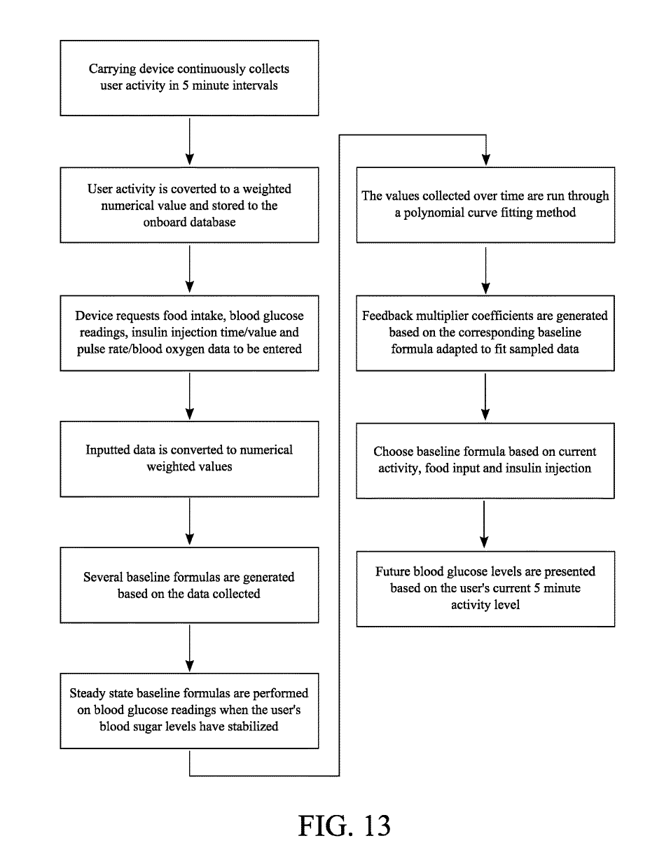

The present invention is a method for predicting a patient's blood glucose level with accuracy up to two hours. The present invention utilizes a small carrying device that will collect user activity, blood glucose readings, food intake, insulin injection data and other variables relevant to blood glucose levels and general fitness. Data is gathered by and inputted to the device, which communicates with a remote server in order to perform predictive blood glucose calculations. Essentially, the present invention functions to accurately derive the user's metabolic rate from a variety of factors, enabling more accurate blood glucose level prediction. A general overview of the process of the present invention is shown in FIG. 13.

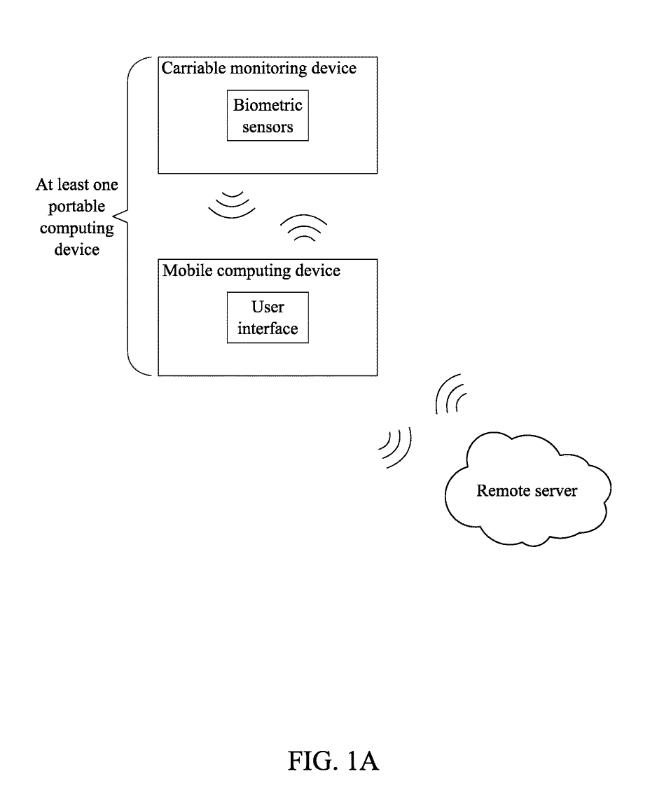

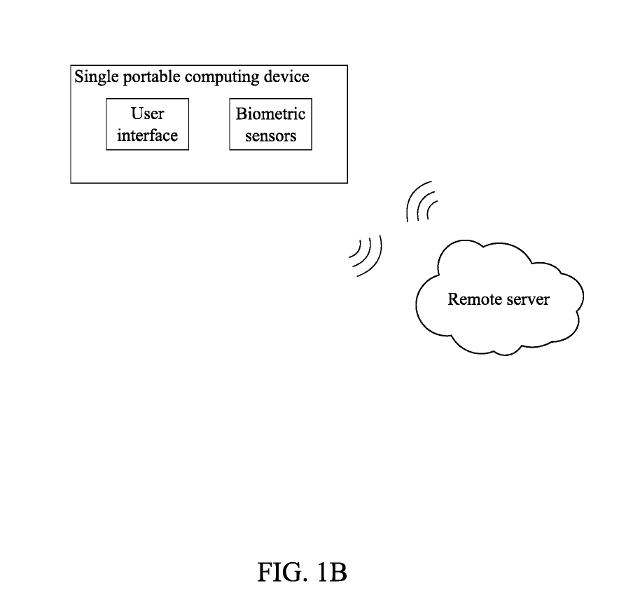

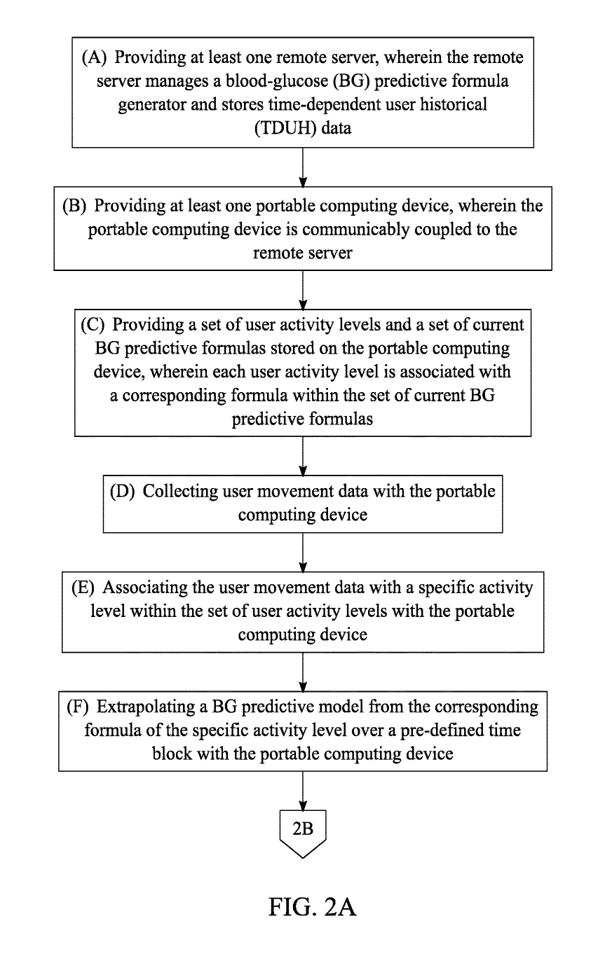

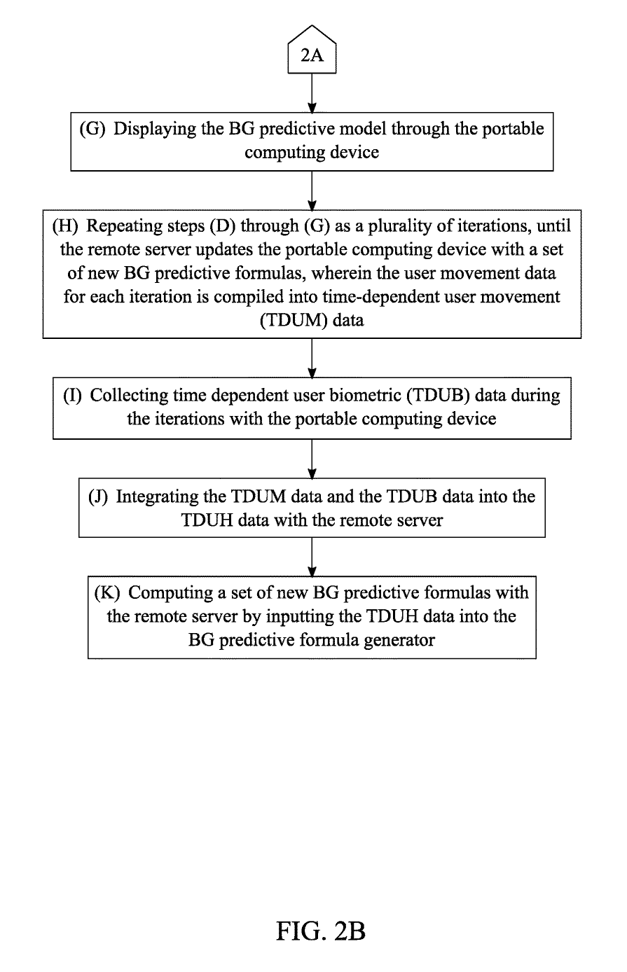

A computing device such as a cell phone or personal computer is utilized as a user interface to view blood glucose predictions and input data into the system. User activity data is continuously collected and categorized into one of multiple activity levels in small sequential time increments. In one embodiment of the present invention, user activity is categorized in five minute intervals. Periodically, the user will be alerted at certain times to input various required variable data for predicting blood glucose levels. Data such as blood glucose readings, food intake, time of insulin injection and insulin value will be entered through an external device such as a mobile phone, glucometer or other external device and sent to the carrying device via a wired or wireless connection. In the preferred embodiment of the present invention, the carrying device will be capable of taking blood oxygen and pulse rate readings. In one embodiment, a pulse oximeter is to be integrated into a button so that such readings can be taken when the user presses a button. General system diagrams with two mobile devices and one mobile device are shown in FIGS. 1 and 2, respectively.

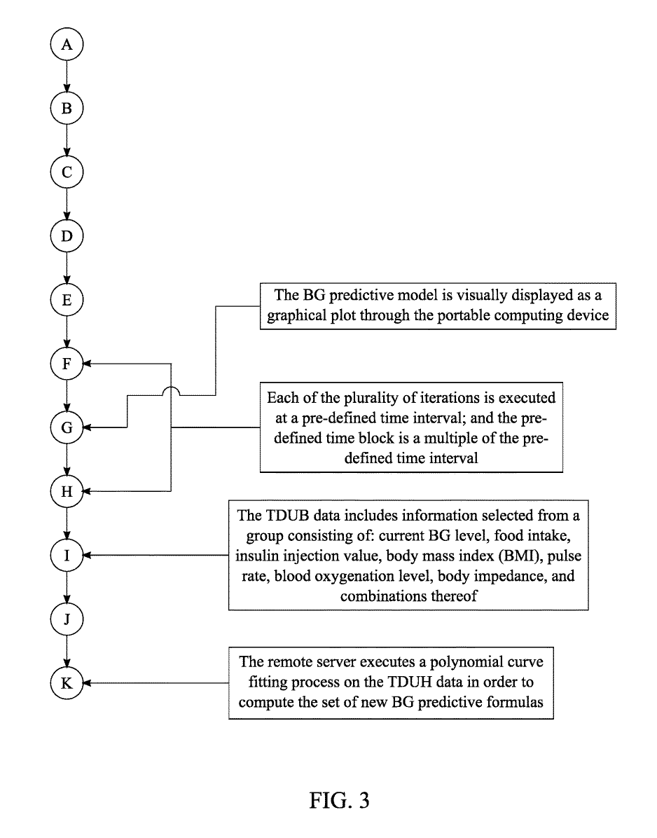

In the general method of the present invention shown in FIGS. 2A-2B, at least one remote server is provided (Step A). The remote server serves as the primary computing element of the present invention and manages a blood-glucose (BG) predictive formula generator and stores time-dependent user historical (TDUH) data. The TDUH data is all data that has been collected for a given user, including, but not limited to, movement data, biometric data, and environmental data, and in general all data is linked to corresponding times the data was collected. In the preferred embodiment, the collected data over time is run through a polynomial curve fitting method to generate a predictive model for the user's future blood glucose levels based on their current activity and metabolic rate. The predictive formula generator is any collection of algorithms, computer code, machine language, or other computer-executable instructions which can convert data collected for the user into BG predictive formulas. Data is run through the predictive formula generator and outputs are produced as coefficients for polynomial functions. Various other details of the method are specified in FIG. 3.

Furthermore, at least one portable computing device is provided (Step B). Each portable computing device is communicably coupled to the remote server. Each portable computing device should have at least one means of electronic communication, such as, but not limited to, a wireless communications chipset such as Wi-Fi, Bluetooth or other wireless communications standards, one or more universal serial bus (USB) ports, or other electronic communication means.

In one embodiment, a single portable device is provided as the at least one computing device. In this embodiment, the single portable device comprises all necessary components necessary to facilitate all described aspects of the at least one portable computing device, such as, but not limited to, an internal movement sensor, biometric sensors and other sensors, wired or wireless electronic communication abilities necessary to communicate with the remote server, a user interface, and other components.

In one embodiment, a carriable monitoring device and a mobile computing device are provided as the at least one portable computing device. The carriable monitoring device is a component with a variety of sensors for collecting data, indicators and wireless or wired connection capabilities to receive and send the collected data. In the preferred embodiment of the present invention, the carriable monitoring device comprises an onboard database, a microcontroller, a 3-axis accelerometer or 9-axis Gyro-accelerometer-compass, a pulse rate sensor, a blood oxygen sensor, an infrared (IR) body temperature sensor, a surface finger temperature sensor, an ambient temperature sensor, a body impedance analysis (BIA) or body mass indicator (BMI) reader, a sweat or dehydration sensor, a humidity sensor, a USB connection, a plurality of buttons, light indicators and Bluetooth and/or Wi-Fi capabilities. An ambient light sensor on the mobile computing device may further supplement the aforementioned components of the carriable monitoring device. The mobile computing device is any electronic device which can interface wired or wirelessly with the carriable monitoring device and which has a user interface for the user to view BG prediction data and input various data. The mobile computing device may be a “smart” cell phone or tablet computer, or laptop computer, or another similar type of device. Preferably, the mobile computing device and the carriable monitoring device are paired in wireless electronic communication through each other Bluetooth or Wi-Fi.

A set of user activity levels and a set of current BG predictive formulas is stored on the portable computing device (Step C). The current BG predictive formulas are generated in a manner to be discussed later. The method of the present is a repeating process, and the present invention is herein described from the standpoint of one or more arbitrary iterations in the process. Each user activity level is associated with a corresponding formula within the set of current BG predictive formulas. The user activity levels are pre-defined in the system. The user activity levels correspond to different levels of user movement detected through the portable device. For example, in one embodiment, the user activity levels comprise six activity levels: stagnant, walk low, walk exercise, jog, run low, and run high. The BG predictive formulas are transient and change over time as the system processes more data and refines the predictive formulas. The BG predictive formulas are received by the portable computing device from the remote server as they are newly generated. This ensures a more accurate representation of the user's activity (as well as other pertinent factors), rather than having a single formula which may only show a very rudimentary representation of the user's activity. The continuous activity readings allow the device to predict future blood glucose levels based on their current state, which may be constantly changing.

For example, if the user's physical activity is drastically changing every five minutes, the predictive model will adjust based on their activity and show a different predictive model for each time period using the corresponding baseline formulas. The device will then present the predictive model onto a paired mobile device where the user will be able to see what their blood glucose levels will be within a two-hour window. The information will preferably be presented in a graph form, where the user can pick and choose a specific time to show the predictive blood glucose level, in 30 minutes or 1 hour for example.

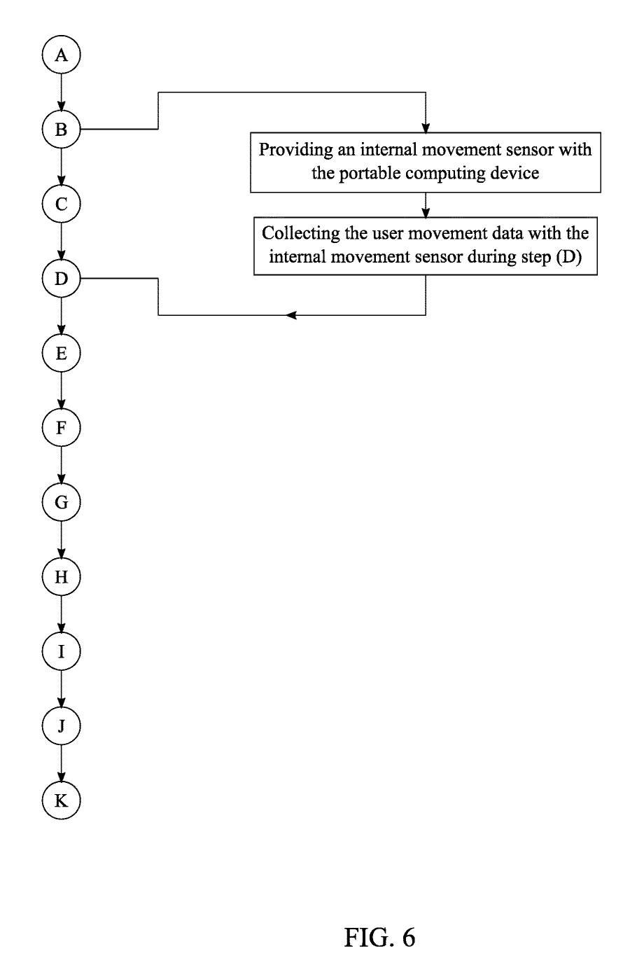

The user carries the portable computing device, which has an internal movement sensor, as specified in FIG. 6. User movement data is collected with the internal movement sensor of the portable computing device (Step D). The internal movement sensor may be any currently existing or new movement sensor capable of measuring movement of the portable computing device through inertial measurements or other means. In one embodiment, the internal movement sensor is a 3-axis MEMS accelerometer. In one embodiment, the movement sensor is a 9-axis gyro-accelerometer-compass. In one embodiment, the internal movement sensor is an inertial measurement unit (IMU).

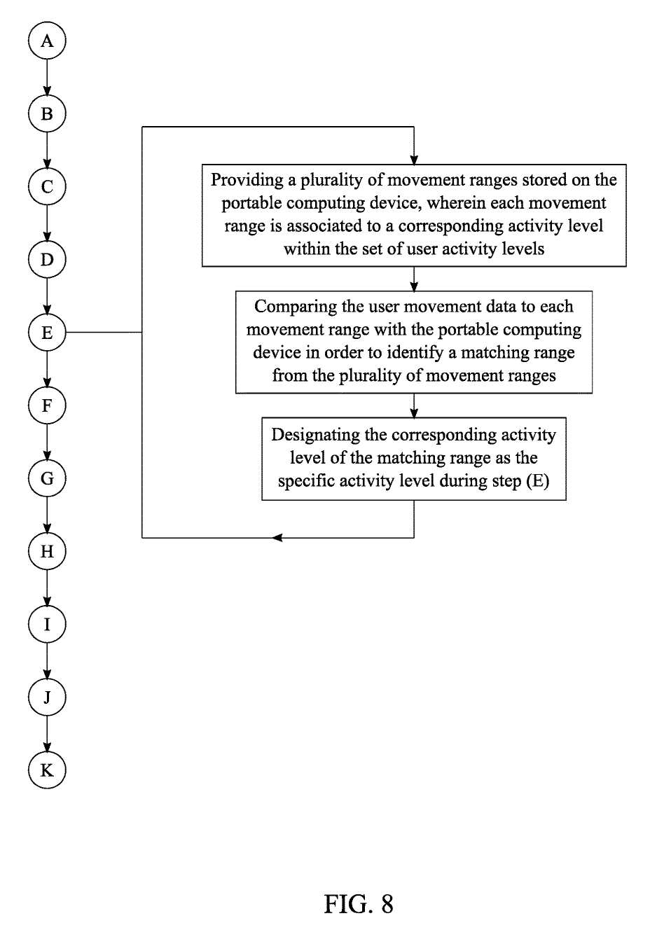

The user movement data is associated with a specific activity level within the set of user activity levels with the portable computing device (Step E). The portable computing device reads the current activity level of the user through the movement sensor and categorizes the user movement data into a range corresponding with one of the user activity levels. Referring to FIG. 8, more particularly, a plurality of movement ranges is provided as stored on the portable computing device, wherein each movement range is associated to a corresponding activity level within the set of user activity levels. The user movement data is compared to each movement range with the portable computing device in order to identify a matching range from the plurality of movement ranges, and a corresponding activity level is designated as the specific activity level. In general, signals received from the movement sensor with higher intensity and/or frequency will be associated with higher user activity levels and vice versa. Alternatively stated, for each five-minute data collection period, the user's activity is categorized into a distinct numerical value representing the level of activity. This numerical value will be stored in the device's onboard database to be sent to the remote server to calculate a baseline formula with the BG predictive formula generator. The baseline formulas depict the varying levels of activity. For example, if there are 6 distinct activity levels for the user, there will be 6 baseline formulas representing each activity level.

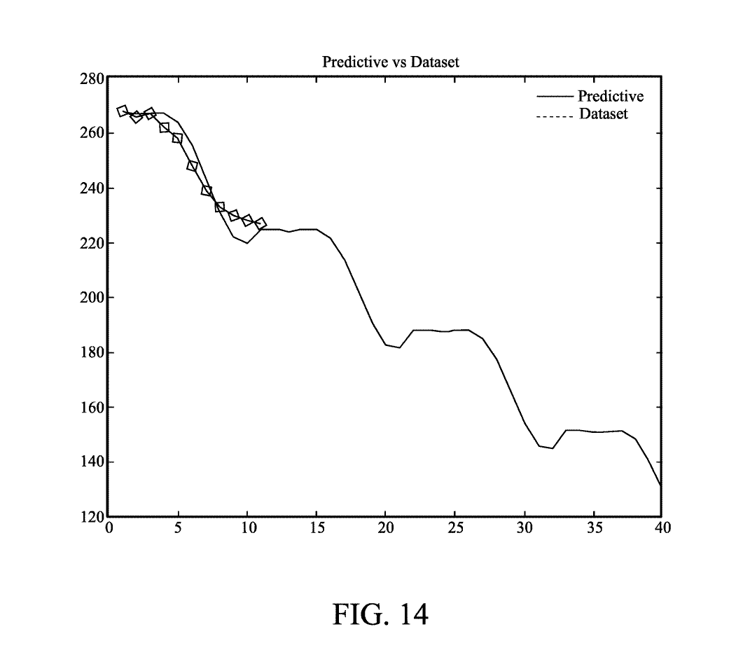

A BG predictive model is extrapolated from the corresponding formula of the specific activity level over a pre-defined time block with the portable computing device (Step F). FIG. 14 shown a graphical representation of an example BG predictive model versus a dataset. It is the intent of the present invention to generate BG predictive models that are accurate for up to two hours from the point of generation, the said two hours being a specific example of the pre-defined time block. The BG predictive model is then displayed through the portable computing device (Step G). More specifically, in the preferred embodiment the BG predictive model is visually displayed as a graphical plot through the portable computing device on a display device of the portable computing device. The BG predictive model displayed on the portable computing device is dependent on which of the activity levels the portable computing device is currently detecting. For example, the BG predictive model will predict the user's BG level to drop faster if the user is at a high activity level as opposed to a low activity level.

Steps D through G are repeated constantly as a plurality of iterations until the remote server updates the portable computing device with a set of new BG predictive formulas (Step H), with the process of steps D through G subsequently repeating with the new BG predictive formulas. The user movement data for each iteration is compiled into time-dependent user movement (TDUM) data. The TDUM data is the collection of user movement data in relation with time. The TDUM data records at which points in time the user was at which user activity levels. In the preferred embodiment, each of the plurality of iterations is executed at a pre-defined time interval. For example, each of the plurality of iterations is executed at a five minute interval. Thus, every five minutes, the portable computing device identifies the user's activity level during the previous five minutes and computes the BG predictive model for the corresponding formula of the activity level of the previous five minutes. If the user switches activity levels between iterations, the BG predictive model for the new iteration will be different than the previous BG model due to using different BG predictive formulas to calculate them, corresponding with the different activity levels. In the preferred embodiment, each BG predictive model is extrapolated with the assumption that the user's activity level will not change. If the user's activity level changes, the BG predictive model will change with the assumption that the new activity level will persist.

The pre-defined time block of the BG predictive model is a multiple of the pre-defined time interval of the plurality of iterations. Knowing the pre-defined time interval of the iterations, the pre-defined time block of the BG predictive model can be achieved by specifying a number of iterations to complete in order to achieve the BG predictive model over the pre-defined time block. For example, if the pre-defined time interval of the iterations is specified as five minutes, then in order to specify the pre-defined time block as two hours, 24 iterations must be completed.

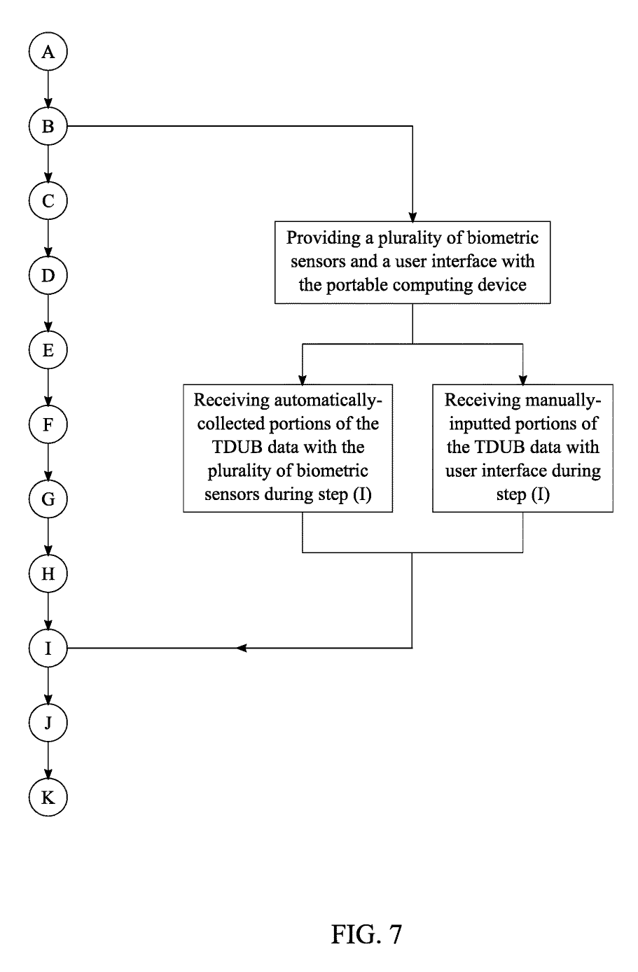

While the said iterations of user movement data collection and BG predictive modeling are occurring, time dependent user biometric (TDUB) data is additionally collected with the portable computing device (Step I). The TDUB data should be understood to be any data pertaining to the user other than movement which may be useful for calculating and predicting the user's BG level. Referring to FIG. 7, in one embodiment, a plurality of biometric sensors is provided with the portable computing device, and an automatically-collected portion of the TDUB data are received with the plurality of biometric sensors. For example, a pulse monitor may be attached to the user at all times, and the user's pulse rate would belong to the automatically-collected portion of the TDUB data.

In one embodiment, a user interface is provided with the portable computing device, and manually-inputted portions of the TDUB data are received through the user interface. The manually-inputted portions of the TDUB data may include, but are not limited to, current BG level, food intake, and insulin injection time and value. In the preferred embodiment, the user is prompted through the portable computing device to input various required data for predicting blood glucose levels. For example, if the TDUH indicates that the user typically eats a meal as 2 o'clock P.M., and the user does not enter food intake information within a specified threshold after 2 o'clock P.M., the user will be prompted through the portable computing device to enter food intake information. Various such reminders and/or alters will be presented to the user throughout the day to input various required data, such as, but not limited to, food intake, insulin injection time and value of insulin injection. It is understood that the indications may be presented through blinking lights on the portable computing device, vibrations, sound alerts or a combination of these methods.

In general, the TDUB data includes information selected from a group consisting of: current BG level, food intake, insulin injection value, body mass index (BMI), pulse rate, blood oxygenation level, body impedance, and combinations thereof. In some embodiments, environmental data may also be collected and included in the TDUH data, such as, but not limited to, ambient temperature, ambient light level, and ambient humidity.

Preferably, a pulse oximeter will be integrated into a button of the portable computing device to take pulse rate and blood oxygen readings. Food intake and blood glucose levels will be entered through external devices and then transferred over to the portable. The user's blood glucose level will be taken via a glucometer and wired to the carrying device via the USB port to transfer the data. The user will have two options in inputting their food intake. Under the first method, the user will input the amount of food eaten and the sugar content of the food. The food intake levels will fall into one of the following categories: light, medium, normal or heavy; while the sugar content of the meal will fall into one of the following categories: low, medium or high. Under the second method, the user will take a picture of their meal via the mobile device. The image will then be processed by the remote server which will then automatically determine the food type, size and sugar content. The insulin injection time and value will also be entered via the mobile device and transferred over to the carrying device. The inputted data such as the food intake, blood glucose level, insulin injection, and pulse rate/blood oxygen will be categorized and converted into a weighted numerical value.

Subsequently, the TDUM data and the TDUB data are integrated into the TDUH data with the remote server. A set of new BG predictive formulas are then computed with the remote server by inputting the TDUH data into the BG predictive formula generator (Step K). The set of new BG predictive formulas may be computed at any time new data is received by the remote server. In general, the larger data set available to the remote server, the better the BG predictive formulas will be; therefore, it is desirable to compute new BG predictive formulas as often as possible. Computation of the new predictive formulas may also be triggered by receiving data considered to be important, such as, but not limited to, current BG level, food intake, or insulin injection. In the preferred embodiment, the remote server executes a polynomial curve fitting process on the TDUH in order to compute the set of new BG predictive formulas. In general, the BG predictive formulas will take the form of:

Ax5+Bx4+Cx3+Dx2+Ex+F

where A, B, C, D, E and F are constants. The constant value F is discarded from the final equation, but used to generate the feedback multiplier coefficients. The present invention will essentially derive the user's metabolic rate from a sample set of data, where the high order coefficients are used to control the user's increasing or decreasing metabolic rate. In other words, the change in the weighted coefficients are based on the user's changing metabolic rate.

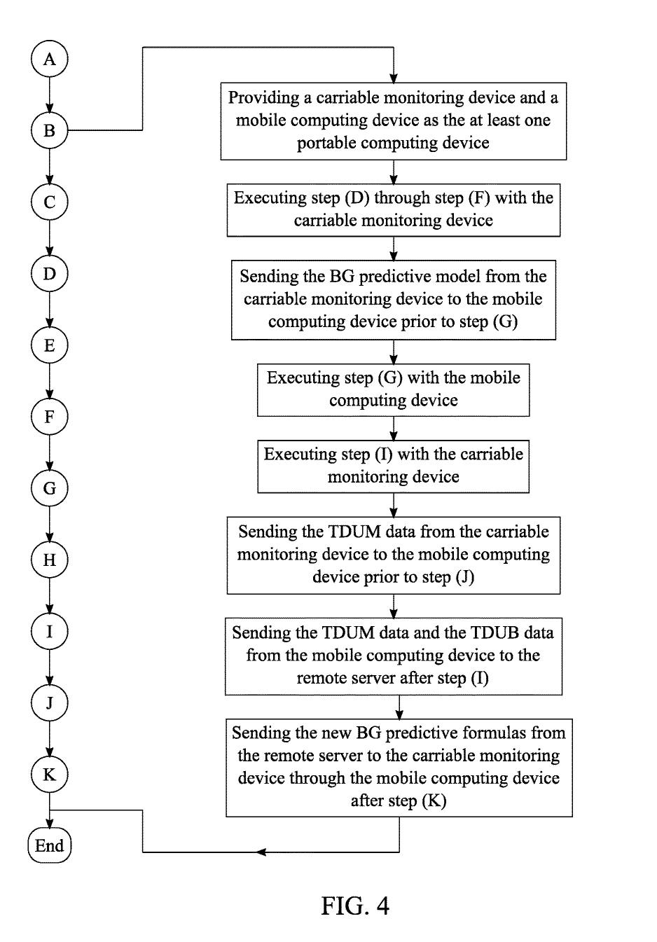

Referring to FIG. 4, in the embodiment where the at least one portable device is provided as a carriable monitoring device and a mobile computing device, steps D through F are executed with the carriable monitoring device, the BG predictive model is sent from the carriable monitoring device to the mobile computing device prior to step G, step G is executed with the mobile computing device, and step I is executed with the carriable monitoring device. Furthermore, the TDUM data is sent from the carriable monitoring device to the mobile computing device prior to step J, the TDUM data and the TDUB data are sent from the mobile computing device to the remote server after step I, and the new BG predictive formulas are sent from the remote server to the carriable monitoring device through the mobile computing device after step K. All information will be stored in the carrying device and will not be stored in the mobile device. The mobile computing device will only serve the purpose of facilitating data input as well as displaying data. At specific times throughout the day, the collected data will be transmitted to the remote server via a Bluetooth low energy or wireless local area network connection. The microcontroller of the carriable monitoring device will be responsible for any numerical conversions, choosing the correct numerical values depending on user activity, as well as sending and receiving information at certain time intervals.

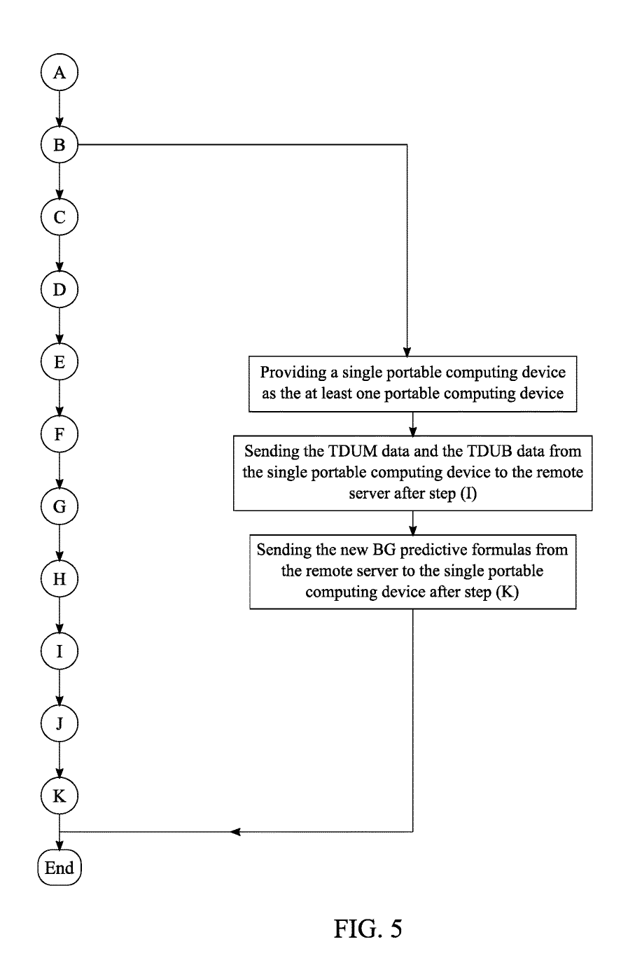

Referring to FIG. 5, in the embodiment where the at least one portable device is provided as a single portable computing device, the TDUM and the TDUB data are sent from the single portable computing device to the remote server after step I, and the new BG predictive formulas are sent from the remote server to the single portable computing device after step K.

In the preferred embodiment of the present invention, all data collected for the user is converted to weighted numerical values and stored to the onboard database. Values such as, but not limited to, food intake level, sugar content of the food intake, measured pulse rate, blood oxygen level, and the other various data are categorized into weighted numerical values. The weighted numerical values are sent to the remote server to generate a unique baseline BG prediction algorithm for the user. In other words, the remote server will run an algorithm based on the various data collected to generate a set of baseline predictive BG formulas used for each predictive blood glucose reading. The corresponding baseline formula is then performed using the blood glucose readings taken when the blood sugar levels have stabilized, typically 1 to 1.5 hours after a meal and/or insulin injection. In the preferred embodiment, the remote server produces the predictive BG formulas in the form as coefficients for a polynomial equation as outputs from a polynomial curve fitting method.

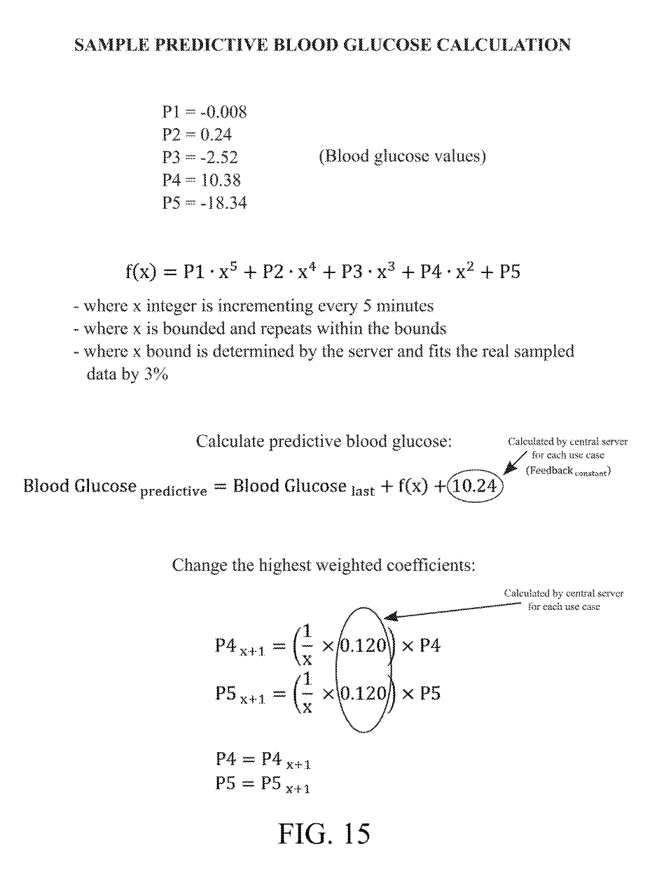

The iterative process of steps D through G is an adaptive feedback loop. Each iteration produces a predictive BG value as output, which the subsequent iteration uses to produce its own predictive output. Additionally, in the preferred embodiment, the independent variable (X) in the BG prediction formulas is an integer which is incremented by one in every iteration. X is bounded and repeats within the bounds, wherein the X bound is determined by the remote server and fits the real sampled data by 3% in the preferred embodiment. Furthermore, the coefficients of the prediction equations are decremented between iterations. FIG. 15 shows a sample calculation.

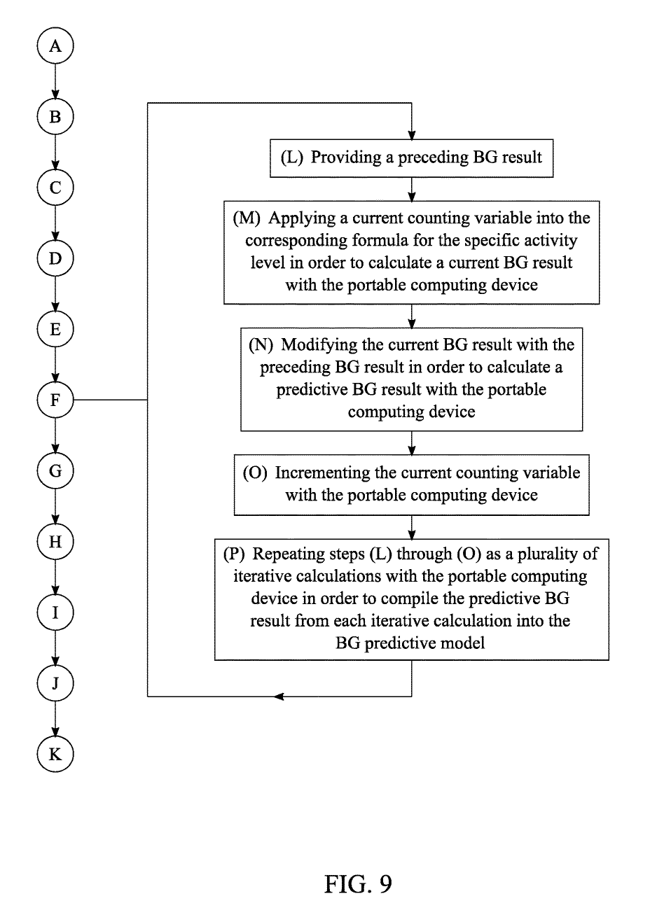

Referring to FIG. 9, providing a preceding BG result (Step L), a current counting variable is applied into the corresponding formula for the specific activity level in order to calculate a current BG result with the portable computing device (step M), more specifically the with the microprocessor of the portable computing device. The current BG result is modified with the preceding BG result in order to calculate a predictive BG result with the portable computing device (Step N). The counting variable is then incremented with the portable computing device (Step 0). Steps L through O are repeated as a plurality of iterative calculations with the portable computing device in order to compile the predictive BG result from each iterative calculation into the BG predictive model (Step P).

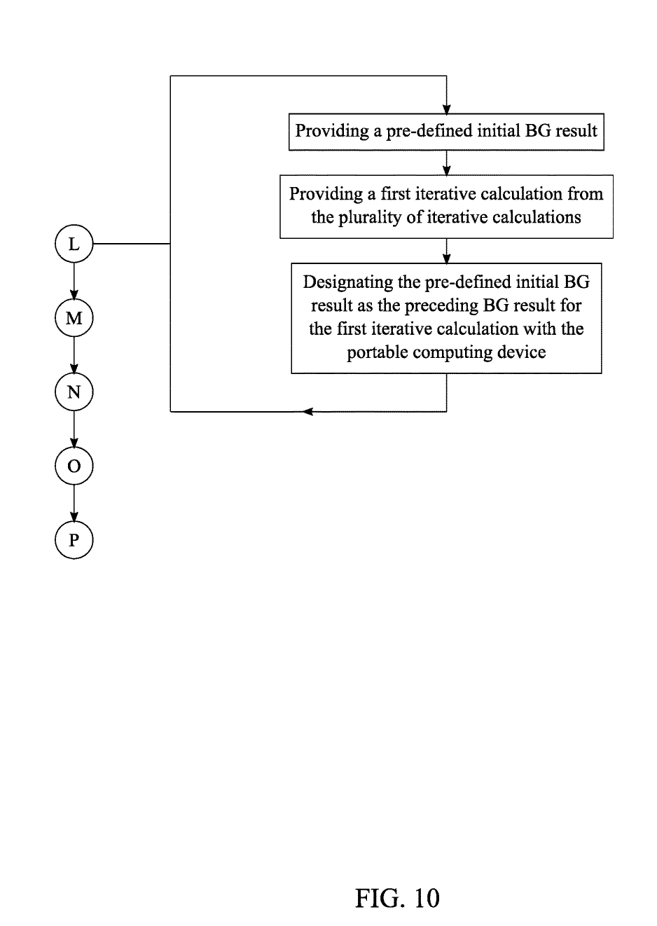

Referring to FIG. 10, for a first iterative calculation from the plurality of iterative calculations, a pre-defined initial BG result is provided. The pre-defined initial BG result will be a value inputted by the user through the user interface. The pre-defined initial BG result is designated as the preceding BG result for the first iterative calculation with the portable computing device.

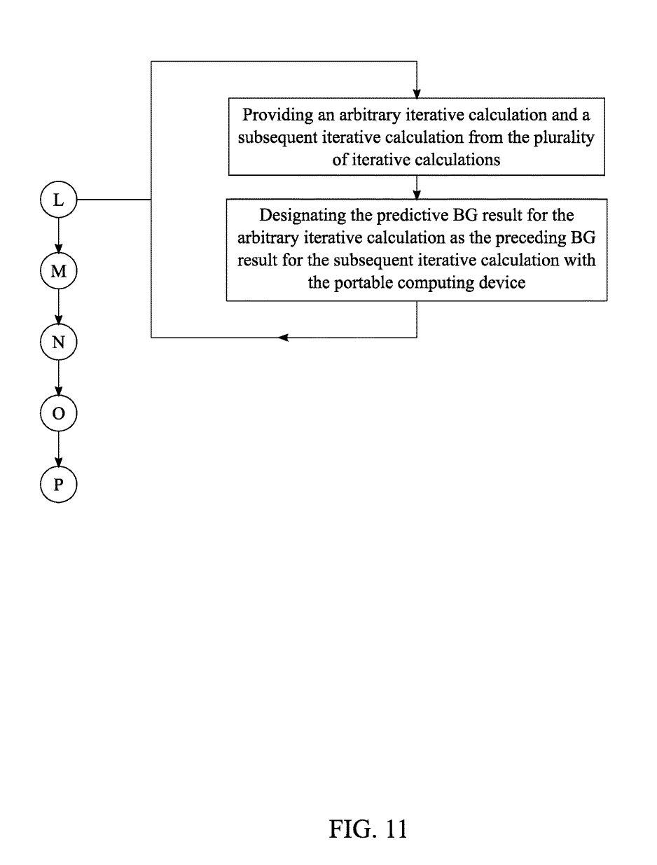

Referring to FIG. 11, for an arbitrary iterative calculation and a subsequent iterative calculation from the plurality of iterative calculations, the predictive BG result for the arbitrary iterative calculation is designated as the preceding BG result for the subsequent iterative calculation with the portable computing device.

Each current BG predictive formula comprises a plurality of polynomial terms, and each polynomial term includes a coefficient. After each iteration, at least one of the polynomial terms of each current BG predictive formula is multiplied by a scaling factor and an inverse of the current counting variable with the portable computing device. This is done in order to scale the corresponding formula for the specific activity level in between steps M and O.

For example, at the beginning of the third iterative calculation or at the end of the second iterative calculation, the counting variable will be incremented from two to three. The value of three will then be inputted into the independent variable of the corresponding formula for the specific activity level, producing the current BG result as output. The predictive BG result is calculated by adding the preceding BG result from the second iterative calculation and the current BG result. In the preferred embodiment, a constant is furthermore generated by BG predictive formula generator of the remote server for each new set of BG predictive formulas and will be added to the preceding BG result and the current BG result to produce the predictive BG result. The predictive BG result from the third iterative calculation then becomes the preceding BG result for the fourth iterative calculation, and the counting variable is incremented from three to four.

Additionally, before the counting variable is incremented from three to four, one or more of the coefficients of the polynomial terms of the corresponding formula is multiplied by ⅓ and by a scaling factor calculated by the remote server. The scaling factor is calculated by the remote server for each new set of BG predictive formulas by the predictive formula generator as part of an artificial intelligence (AI) learning analytics algorithm. Thus, the system will continuously generate a new predictive model based on the changing user activity. This information will then be displayed on the user's mobile device. The user will be presented with a graph depicting their predicted blood glucose levels over a two-hour time period. The user will be able to choose a specific time within the two-hour window (i.e. 30 minutes from now, 1 hour from now, etc.) to see what their predicted blood glucose level will be.

Furthermore, in one embodiment, other data collected by the portable computing device such as the environmental temperature, humidity, light sensed, body mass index (BMI), patient core and skin temperature, etc. will be sent to a physician. The physician will then be able to remotely review the data and determine the physical fitness level of the user, which can be indicated on the mobile device. For example, a high pulse rate and BMI assigned to a lower numerical physical activity value will indicate that the user has poor physical fitness. Thus, the present invention not only facilitates accurate and effective blood glucose levels for diabetics and other individuals who need to engage in such a practice, but can also facilitate general health awareness.

Although the invention has been explained in relation to its preferred embodiment, it is to be understood that many other possible modifications and variations can be made without departing from the spirit and scope of the invention as hereinafter claimed.

What is claimed is:

1. A method of adaptively predicting blood-glucose level by collecting biometric and activity data with a user portable device, the method comprises the steps of:
(A) providing at least one remote server, wherein the remote server manages a blood-glucose (BG) predictive formula generator and stores time-dependent user historical (TDUH) data;
(B) providing at least one portable computing device, wherein the portable computing device is communicably coupled to the remote server;
(C) providing a set of user activity levels and a set of current BG predictive formulas stored on the portable computing device, wherein each user activity level is associated with a corresponding formula within the set of current BG predictive formulas;
(D) collecting user movement data with the portable computing device;
(E) associating the user movement data with a specific activity level within the set of user activity levels with the portable computing device;
(F) extrapolating a BG predictive model from the corresponding formula of the specific activity level over a pre-defined time block with the portable computing device;
(G) displaying the BG predictive model through the portable computing device;
(H) repeating steps (D) through (G) as a plurality of iterations, until the remote server updates the portable computing device with a set of new BG predictive formulas, wherein the user movement data for each iteration is compiled into time-dependent user movement (TDUM) data;
(I) collecting time dependent user biometric (TDUB) data during the iterations with the portable computing device;
(J) integrating the TDUM and the TDUB data into the TDUH data with the remote server; and
(K) computing a set of new BG predictive formulas with the remote server by inputting the TDUH data into the BG predictive formula generator.

2. The method as claimed in claim 1 comprises the steps of:
providing a carriable monitoring device and a mobile computing device as the at least one portable computing device;
executing step (D) through step (F) with the carriable monitoring device;
sending the BG predictive model from the carriable monitoring device to the mobile computing device prior to step (G);
executing step (G) with the mobile computing device;
executing step (I) with the carriable monitoring device;
sending the TDUM data from the carriable monitoring device to the mobile computing device prior to step (J);
sending the TDUM data and the TDUB data from the mobile computing device to the remote server after step (I); and
sending the new BG predictive formulas from the remote server to the carriable monitoring device through the mobile computing device after step (K).

3. The method as claimed in claim 1 comprises the steps of:
providing a single portable computing device as the at least one portable computing device;
sending the TDUM data and the TDUB data from the single portable computing device to the remote server after step (I); and
sending the new BG predictive formulas from the remote server to the single portable computing device after step (K).

4. The method as claimed in claim 1 comprises the steps of:
providing an internal movement sensor with the portable computing device; and
collecting the user movement data with the internal movement sensor during step (D).

5. The method as claimed in claim 1 comprises the steps of:
providing a plurality of biometric sensors with the portable computing device; and
receiving automatically-collected portions of the TDUB data with the plurality of biometric sensors during step (I).

6. The method as claimed in claim 1 comprises the steps of:
providing a user interface with the portable computing device; and
receiving manually-inputted portions of the TDUB data with the plurality of biometric sensors during step (I).

7. The method as claimed in claim 1, wherein the TDUB data includes information selected from a group consisting of: current BG level, food intake, insulin injection value, body mass index (BMI), pulse rate, blood oxygenation level, body impedance, and combinations thereof.

8. The method as claimed in claim 1 comprises the steps of:
providing a plurality of movement ranges stored on the portable computing device, wherein each movement range is associated to a corresponding activity level within the set of user activity levels;
comparing the user movement data to each movement range with the portable computing device in order to identify a matching range from the plurality of movement ranges; and
designating the corresponding activity level of the matching range as the specific activity level during step (E).

9. The method as claimed in claim 1, wherein the BG predictive model is visually displayed as a graphical plot through the portable computing device.

10. The method as claimed in claim 1, wherein:
each of the plurality of iterations is executed at a pre-defined time interval; and
the pre-defined time block is a multiple of the pre-defined time interval.

11. The method as claimed in claim 1 comprises the steps of:
(L) providing a preceding BG result;
(M) applying a current counting variable into the corresponding formula for the specific activity level in order to calculate a current BG result with the portable computing device;
(N) modifying the current BG result with the preceding BG result in order to calculate a predictive BG result with the portable computing device;
(O) incrementing the current counting variable with the portable computing device; and
(P) repeating steps (L) through (O) as a plurality of iterative calculations with the portable computing device in order to compile the predictive BG result from each iterative calculation into the BG predictive model.

12. The method as claimed in claim 11 comprises the steps of:
providing a pre-defined initial BG result;
providing a first iterative calculation from the plurality of iterative calculations; and
designating the pre-defined initial BG result as the preceding BG result for the first iterative calculation with the portable computing device.

13. The method as claimed in claim 11 comprises the steps of:
providing an arbitrary iterative calculation and a subsequent iterative calculation from the plurality of iterative calculations; and
designating the predictive BG result for the arbitrary iterative calculation as the preceding BG result for the subsequent iterative calculation with the portable computing device.

14. The method as claimed in claim 11 comprises the steps of:
providing a plurality of polynomial terms for each current BG predictive formula, wherein each polynomial term includes a coefficient; and
multiplying at least one of the polynomial terms by a scaling factor and an inverse of the current counting variable with the portable computing device in order to scale the corresponding formula for the specific activity level prior in between step (M) and (O).

15. The method as claimed in claim 1, wherein the remote server executes a polynomial curve fitting process on the TDUH data in order to compute the set of new BG predictive formulas.
